(19) United States
(12) Patent Application Publication
(10) Pub. No.: US 2018/0188031 A1
(43) Pub. Date: Jul. 5, 2018

(54) SYSTEM AND METHOD FOR CALIBRATING VEHICLE DYNAMICS EXPECTATIONS FOR AUTONOMOUS VEHICLE NAVIGATION AND LOCALIZATION

(71) Applicant: Faraday&Future Inc., Gardena, CA (US)

(72) Inventors: Juan Pablo Samper, Mountain View, CA (US); Carlos John Rosario, San Jose, CA (US)

(21) Appl. No.: 15/691,614

(22) Filed: Aug. 30, 2017

Related U.S. Application Data
(60) Provisional application No. 62/382,205, filed on Aug. 31, 2016.

(51) Int. Cl. G01C 21/16; G01C 21/28; G05D 1/00; G05D 1/02; B60W 10/20; B60W 30/06; B60W 40/101

(52) U.S. Cl. CPC G01C 21/165; G01C 21/28; G05D 1/0088; B60W 2050/0002; B60W 10/20; B60W 30/06; B60W 40/101; G05D 1/0212

(57) ABSTRACT

A system that performs a method is disclosed. While navigating a vehicle along a path, the system determines a starting point along the driving path, and monitors a vehicle trajectory, wherein the vehicle trajectory comprises odometry information. The system calculates an expected ending point of the vehicle trajectory using the starting point, the odometry information, and vehicle dynamics expectations, and determines whether there is a difference between the ending point and the expected ending point that is greater than a threshold distance. In response to the determination: in accordance with a determination that the difference between the ending point and the expected ending point is greater than the threshold distance, the system calibrates the vehicle dynamics expectations. In accordance with a determination that the difference between the ending point and the expected ending point is not greater than the threshold distance, the system foregoes calibrating the vehicle dynamics expectations.

### CROSS-REFERENCE TO RELATED APPLICATIONS

This application claims the benefit of U.S. Provisional Application No. 62/382,205, filed Aug. 31, 2016, the entirety of which is hereby incorporated by reference.

### FIELD OF THE DISCLOSURE

The various embodiments of the present invention relate generally to calibrating vehicle dynamics expectations for accurate autonomous vehicle navigation and localization.

### BACKGROUND OF THE DISCLOSURE

Modern vehicles, especially automobiles, increasingly combine Global Navigation Satellite Systems (GNSS) (e.g., Global Positioning System (GPS), BeiDou, Galileo, etc.) and odometry or dead reckoning information to determine a vehicle's location. Autonomous vehicles can use such information for performing autonomous driving operations. Vehicle odometry, however, can be inaccurate due vehicle dynamics such as wheel slip and/or tire pressure (e.g., tire size) variations. Therefore, a solution to automatically calibrate vehicle dynamics expectations for accurate autonomous vehicle navigation and localization is desirable.

### SUMMARY OF THE DISCLOSURE

Examples of the disclosure are directed to calibrating vehicle dynamics expectations for accurate autonomous vehicle navigation and localization. An autonomous vehicle can use a plurality of cameras and/or sensors to monitor vehicle odometry and vehicle dynamics for accurate autonomous vehicle navigation. In this way, autonomous vehicles can accurately navigate a desired driving path and accurately determine its location even when other localization systems are unavailable.

### BRIEF DESCRIPTION OF THE DRAWINGS

FIG. 1 illustrates exemplary vehicle dynamics according to examples of the disclosure.

FIG. 2 illustrates an exemplary graph showing a relationship between slip angle and lateral force according to examples of the disclosure.

FIG. 3A illustrates an exemplary vehicle autonomously driving along a driving path according to examples of the disclosure.

FIG. 3B illustrates an exemplary vehicle automatically correcting its steering along a driving path according to examples of the disclosure.

FIG. 3C illustrates an exemplary vehicle automatically correcting its steering along a driving path according to examples of the disclosure.

FIG. 4 illustrates an exemplary process for calibrating vehicle dynamics expectations according to examples of the disclosure.

FIG. 5 illustrates an exemplary process for localizing a vehicle using calibrated vehicle dynamics expectations according to examples of the disclosure.

FIG. 6 illustrates an exemplary system block diagram of a vehicle control system according to examples of the disclosure.

### DETAILED DESCRIPTION

In the following description of examples, references are made to the accompanying drawings that form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

Some vehicles, such as automobiles, may include GPS systems for determining a vehicle's location. However, GPS systems are line-of-sight technologies that require at least four satellites to make an accurate location determination and may not provide accurate results in certain circumstances. For examples, GPS systems may not be accurate or may be available when the vehicle is beneath a bridge, in a parking garage, in a tunnel, in an area with tall buildings, or in any other situation where the vehicle may not have a direct line of sight to sufficient GPS satellites. In such circumstances, vehicle odometry can be used to determine the vehicle's location. Vehicle odometry, however, can also be inaccurate due to other factors such as drift (e.g., gradual changes), in which a small miscalculation can become larger over time. Wheel slip and/or tire pressure (e.g., tire size) variations can cause drift. Examples of the disclosure are directed to calibrating vehicle dynamics expectations for accurate vehicle localization and navigation.

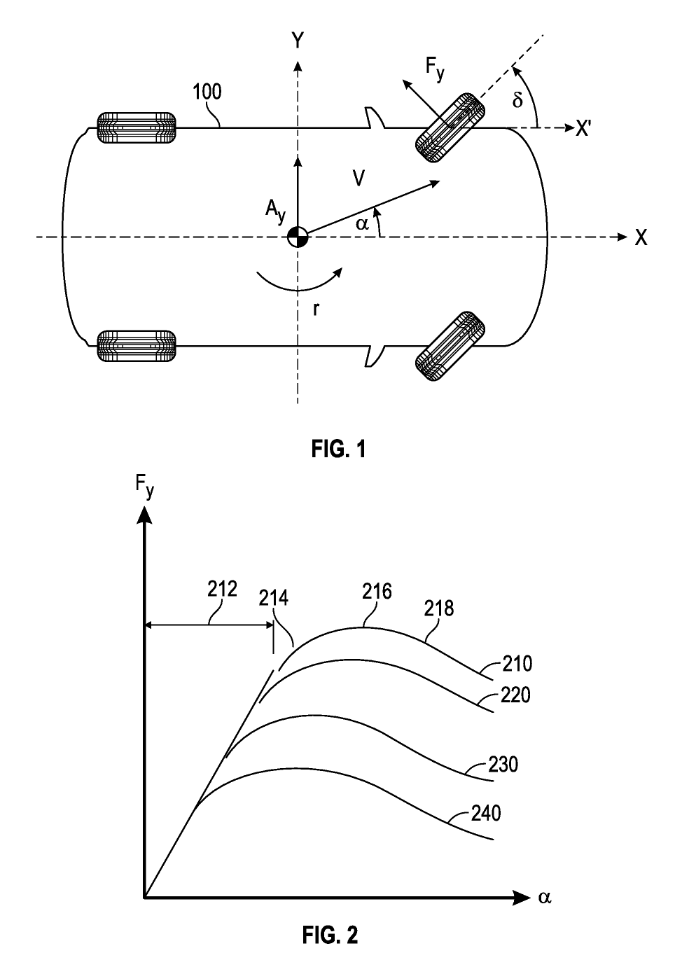

FIG. 1 illustrates exemplary vehicle dynamics according to examples of the disclosure. Vehicle 100 can be traveling at velocity V as it rotates its wheels to steering angle δ to perform a driving operation such as a turning maneuver. During a turning maneuver, the tires slip laterally and generate lateral force F_{y}. The angle between the direction of motion and the X axis is slip angle α. During a turning maneuver, the vehicle rotates at yaw rate “r” and generates lateral acceleration “A_{y}.” In some situations, each wheel can spin at a different rate (e.g., low inflated tires spinning faster than higher inflated tires). Not only can these vehicle dynamics characteristics be used to predict and plan vehicle trajectories to follow desired driving paths, these vehicle dynamics characteristics can be used to determine a vehicle's location as described in further detail below.

FIG. 2 illustrates an exemplary graph showing a relationship between slip angle and lateral force (e.g., as described above with reference to FIG. 1) according to examples of the disclosure. For example, curve 210 illustrates how the relationship between slip angle and lateral force is initially linear around region 212 and begins to curve around point 214. A vehicle can have steady steering control around region 212 of curve 210, but the tires may begin to squeak around point 214. The lateral force will peak around point 216, and the tires may begin to skid around point 218 or at any point after point 216. Curves 220, 230, and 240 represent different conditions with lower peak lateral forces at lower slip rates. In other words, curves 220, 230, and 240 can represent scenarios where a vehicle's tires can skid more easily, affecting vehicle odometry. This downward trend can occur over time as tires begin to wear out (e.g., lose traction). Each of curves 210, 220, 230, and 240 can also represent how vehicle odometry is affected by road conditions. For example, curve 210 can represent a vehicle driving on a paved road, curve 220 can represent the vehicle driving on a dirt road, curve 230 can represent the vehicle driving on a wet paved road (e.g., in rainy weather conditions), and curve 240 can represent a vehicle driving on an icy road (e.g., in snowy weather conditions). These increasingly slippery conditions would have lower lateral force peaks and would begin to skid at lower slip angles, respectively.

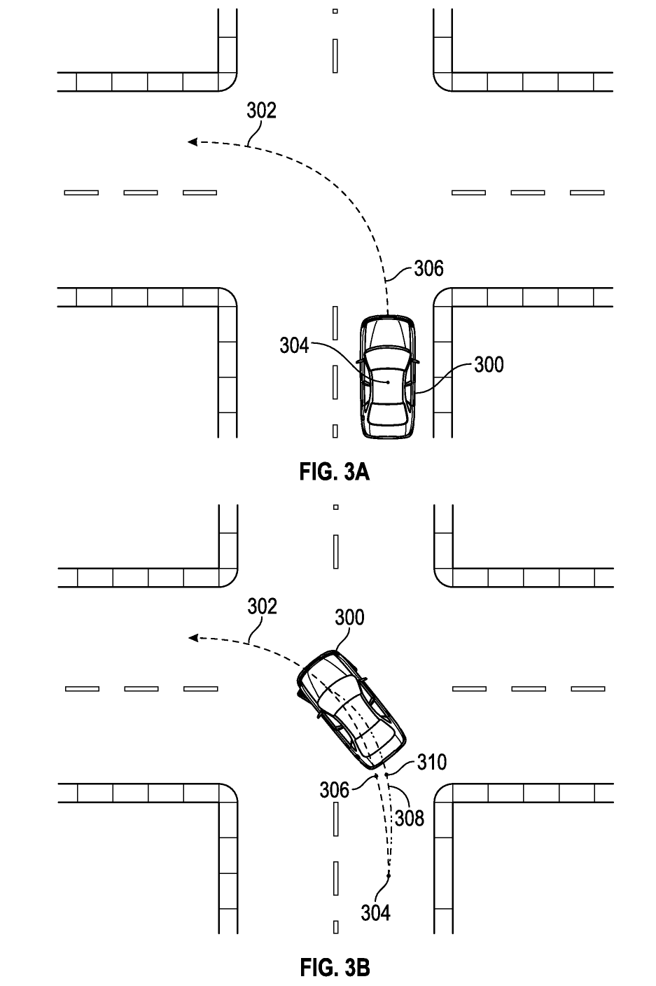

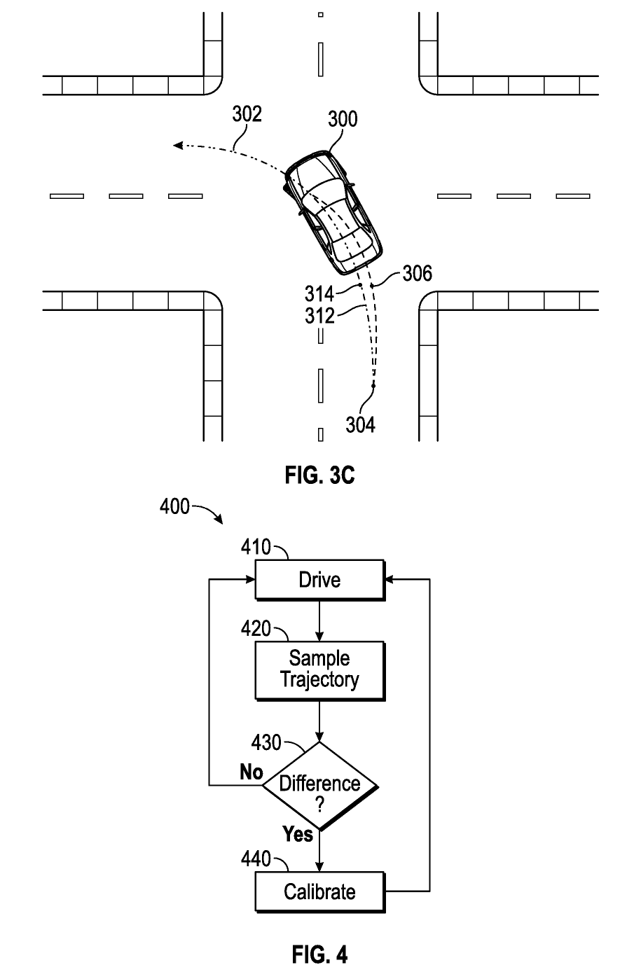

FIG. 3A illustrates an exemplary vehicle 300 autonomously driving along path 302 according to examples of the disclosure. While vehicle 100 is driving along path 102, vehicle 100 ensures that it stays on the path. For example, vehicle 100 can determine its location as it drives along path 102 through GPS receivers, optical cameras, ultrasound sensors, radar sensors, LIDAR sensors, cellular positioning systems, Wi-Fi systems, map-matching techniques, cloud services, and any other system or sensor that can be used to determine a vehicle's location. Vehicle 100 can also be equipped with a plurality of sensors for monitoring vehicle odometry information such as the vehicle's heading, speed (including acceleration and deceleration using an inertial measurement unit (IMU), for example), steering angle (and/or steering wheel revolutions), wheel revolutions (including average wheel revolutions), etc. For example, the vehicle can be equipped with speed sensors at each wheel to measure wheel revolutions. In this way, the vehicle can track how far it travels per wheel revolution or per average wheel revolution. In some examples, the vehicle can use the wheel speed sensors from its anti-lock braking system (ABS) to monitor the vehicle's odometry. In some examples, the vehicle can be equipped with tire pressure sensors and/or tire wear sensors. In some examples, the vehicle can be equipped with one or more accelerometers for measuring acceleration, and/or one or more gyroscopes for measuring angular velocity (e.g., included in an IMU). In some examples, vehicle 300 can include a plurality of cameras and/or sensors around the exterior of the vehicle to capture images or data of the vehicle's surroundings. These cameras and/or sensors can be positioned on the front, back, and sides of the vehicle to enable them to capture images and data within 360 degrees of the vehicle during driving operations. These images and data can be used to determine and monitor the vehicle's trajectory. The plurality of sensors for monitoring the vehicle's odometry information can be used to determine the vehicle's location as described below. The plurality of sensors for monitoring the vehicle's odometry can be used to determine the vehicle's expected location at a point along driving path 302. For example, vehicle 300 can determine the vehicle's expected location 306 along driving path 302 by calculating its trajectory from starting point 304 using the vehicle's odometry information (e.g., heading, steering angle, wheel revolutions, etc.) and vehicle dynamics expectations (e.g., slip angle, lateral force, yaw rate, or distance travelled per wheel revolution or per average wheel revolution) to follow driving path 302. In this way, vehicle 300 can verify that it is indeed driving along driving path 302 (e.g., is not veering off of the desired path) as described below.

FIG. 3B illustrates an exemplary vehicle 300 automatically correcting its steering along driving path 302 according to examples of the disclosure. As described above, vehicle 300 can include a plurality of cameras and/or sensors around the exterior of the vehicle to capture images or data of the vehicle's surroundings. These cameras and/or sensors can be positioned on the front, back, and sides of the vehicle to enable them to capture images and data within 360 degrees of the vehicle during driving operations. These images and data can be used to monitor driving trajectory 308. Vehicle trajectory 308 shows that vehicle 300 understeered driving path 302. In some examples, the understeering can be detected by determining whether there is a difference between the vehicle's actual location at point 310 to the vehicle's expected location 306 (e.g., whether the difference between the vehicle's actual location at point 310 to the vehicle's expected location 306 is greater than some threshold distance). For example, the threshold distance between point 310 and expected location 306 can be 3 or more inches, a foot, or a meter, for example. In some examples, the vehicle's location at point 310 can be determined with GPS receivers, optical cameras, ultrasound sensors, radar sensors, LIDAR sensors, cellular positioning systems, and any other systems or sensors that can be used to determine a vehicle's location without vehicle odometry. Once the difference between point 310 and expected location 306 is detected, vehicle 300 can correct its steering to merge its trajectory into driving path 302. The detected difference between point 310 and expected location 306 can be a result of inaccurate vehicle dynamics expectations (e.g., slip angle, lateral force, or distance traveled per tire revolution) because of tire conditions (e.g., tire size, tire wear, or wheel alignment), road conditions (e.g., wet or icy), the road surface material (e.g., dirt or gravel), or any other conditions that would cause the vehicle to have a lower lateral force for a slip angle (e.g., as described above with references to FIGS. 1-2). In some examples, the vehicle can use the difference between point 310 and expected location 306 to calibrate vehicle dynamics expectations for accurate vehicle navigation and localization (e.g., as described above with references to FIGS. 1-2). For example, vehicle 300 can update the slip angle for the steering angle used in trajectory 308. In some examples, vehicle 300 can increase its steering angle accordingly to achieve the desired turning angle (e.g., slip angle) of path 302. In this way, the vehicle can accurately follow path 302 the next time it performs similar driving maneuvers.

FIG. 3C illustrates an exemplary vehicle 300 automatically correcting its steering along driving path 302 according to examples of the disclosure. Vehicle trajectory 312 shows that vehicle 300 oversteered driving path 302. In some examples, the oversteering can be detected by determining whether there is a difference between the vehicle's actual location at point 314 to the vehicle's expected location 306 (e.g., whether the difference between the vehicle's actual location at point 314 to the vehicle's expected location 306 is greater than some threshold distance). For example, the threshold distance between point 314 and expected location 306 can be three or more inches, a foot, or a meter, for example. In some examples, the vehicle's location at point 314 can be determined with GPS receivers, optical cameras, ultrasound sensors, radar sensors, LIDAR sensors, map-matching systems (e.g., comparing LIDAR data to a highly automated driving map), cellular positioning systems, and any other systems or sensors that can be used to determine a vehicle's location without vehicle odometry. Once the difference between point 314 and expected location 306 is detected, vehicle 300 can correct its steering to merge its trajectory into driving path 302. The difference between point 314 and expected location 306 can be a result of inaccurate vehicle dynamics expectations (e.g., as described above with references to FIGS. 1-3B). In some examples, the vehicle can use the detected difference between point 314 and expected location 306 to calibrate vehicle dynamics expectations (e.g., as described above with references to FIGS. 1-3A). For example, vehicle 300 can update the slip angle for the steering angle used in trajectory 312. In some examples, vehicle 300 can decrease its steering angle accordingly to achieve the desired turning angle of path 302. In this way, the vehicle can accurately follow path 302 the next time it performs similar driving maneuvers.

FIG. 4 illustrates an exemplary process 400 for calibrating vehicle dynamics expectations according to examples of the disclosure. Process 400 can be performed continuously or repeatedly by the vehicle during driving procedures. Process 400 can also be performed periodically (e.g., once every hour or once every mile).

At step 410, the vehicle can be operating in an automated driving mode (e.g., driving autonomously without user input) or in an assisted driving mode (e.g., automatically parking, changing lanes, following the flow of traffic, staying within its lane, pulling over, or performing any other automated driving operation). The vehicle can also be performing any driving operation (e.g., driving in a straight line, turning right or left, making a U-turn, changing lanes, merging into traffic, reversing, accelerating, and/or decelerating) while following a planned trajectory (e.g., path). The planned trajectory can be comprised of a set of instructions (e.g., heading, speed, steering angle, and number of wheel rotations) for performing automated driving maneuvers that are calculated based in part on vehicle dynamics expectations (e.g., how far the vehicle travels per wheel revolution or per average wheel revolution and/or the slip angles associated with certain steering angles).

At step 420, process 420 monitors a sample of the vehicle's trajectory from a starting point to an ending point (e.g., as described above with references to FIGS. 3A-3C). For example, the vehicle can determine the location of a sample starting point (e.g., the vehicle's location at the start of monitored trajectory), monitor vehicle odometry and the vehicle's actual trajectory (including the vehicle's heading), and determine the location of the ending point (e.g., the vehicle's actual location at the end of the monitored trajectory). In some examples, process 400 can monitor external information such as weather conditions (e.g., whether it is currently or was recently snowing or raining) and/or map information, including information about the surface material of the road (e.g., pavement, dirt, asphalt, or gravel), at step 420. In some examples, this external information can be monitored through the vehicle's sensors (e.g., as described above with reference to FIGS. 3A-3C) or can be obtained from an external source (e.g., another vehicle and/or an internet source).

At step 430, process 400 can determine whether vehicle dynamics expectations are accurate. As described above, determining whether vehicle dynamics expectations are accurate can involve comparing the planned vehicle trajectory to the vehicle's actual trajectory. For example, process 400 can calculate the expected ending point of the monitored trajectory using the trajectory starting point, the vehicle odometry (e.g., steering angle, and/or tire revolutions), and one or more vehicle dynamics expectations (e.g., how far the vehicle travels per wheel revolution or per average wheel revolution and/or the slip angles associated with certain steering angles) (e.g., as described above with reference to FIGS. 3A-3C). The vehicle can also determine its actual ending point (e.g., as described above with reference to FIGS. 3A-3C). Process 400 can then determine whether there is a difference between the expected ending point and the actual ending point (e.g., whether the difference between the expected ending point and the actual ending point is greater than some threshold distance). For example, the threshold distance between the expected ending point and the actual ending point can be 3 or more inches, a foot, or a meter, for example. In accordance with a determination that there is no difference between the expected ending point and the actual ending point, process 400 returns to step 410. In accordance with a determination that there is a difference between the expected ending point and the actual ending point, process 400 transitions to step 440. For example, if vehicle dynamics expectations are that the vehicle travels at 1.5 feet per wheel revolution (or per average wheel revolution) and the vehicle travelled 10 wheel revolutions during the monitored trajectory at step 420, the vehicle would estimate that it travelled 150 feet. If the actual end point indicates that the vehicle only travelled 100 feet and not the expected 150 feet, a difference between the expected ending point and the actual ending point (e.g., 50 feet) is determined. In some examples, the difference between the expected ending point and the actual ending point could be due to low tire pressure (e.g., smaller wheel radius), tire wear, the use of a spare tire, driving on a punctured run-flat tire, or any other condition that would reduce the distance the vehicle travels per wheel revolution. In some examples, process 400 can determine differences between the expected ending point and the actual ending point due to oversteering and/or understeering during driving operations (e.g., as described above with references to FIGS. 3A-3C).

At step 440, process 400 can calibrate vehicle dynamics expectations (e.g., as described above with reference to FIGS. 1-3C). For example, process 400 can calibrate the vehicle's dynamics expectation for distance traveled per wheel revolution or per average wheel revolution. As discussed above, if the vehicle only traveled 100 feet after performing 10 wheel revolutions but the vehicle was expected to travel 150 feet (e.g., at a rate of 1.5 feet per wheel revolution), process 400 can update the vehicle dynamics expectation for distance traveled per wheel revolution to 1 foot per wheel revolution. In some examples, process 400 can also calibrate other vehicle dynamics expectations such as the slip angle associated with the steering angle used in the monitored trajectory (e.g., as described above with references to FIGS. 3A-3C). In some examples, process 400 can also update the set of instructions (e.g., heading, speed, steering angle, and number of wheel rotations) for completing the planned trajectory based on the vehicle's calibrated vehicle dynamics expectations at step 440 (e.g., as described above with reference to FIGS. 3A-3C). For instance, in the above example where the vehicle traveled 100 feet after 10 wheel revolutions, process 400 can update the set of instructions for completing the planned directory at step 440 to cause the vehicle to travel an additional 5 revolutions (e.g., an additional 50 feet) at step 410. In another example, process 400 can update the set of instructions for completing the planned trajectory to account for changes in the slip angle for a given steering angle at step 440 (e.g., as described above with references to FIGS. 3A-3C). Once vehicle dynamics expectations are calibrated, process 400 can return to step 410 to execute the updated set of instructions for completing the planned trajectory (e.g., with the corrected instructions for the steering angle and/or number of wheel revolutions).

In some examples, process 400 can make calibrations to vehicle dynamics expectations at step 440 that take incorporate any external information monitored or received at step 420. For example, if the external information monitored at step 420 indicates that the road is wet (e.g., is currently raining or was recently raining), the calibrations can be limited to the current weather conditions and may not be used for different weather conditions. In another example, if the external information observed at step 420 indicates that the surface material of the road is dirt, the vehicle calibrations can be saved for the specific road and/or for dirt roads generally.

In some examples, process 400 can be used to optimize racing maneuvers. For example, the vehicle can use its sensors to monitor vehicle dynamics (e.g., as described above with references to FIGS. 1-4), and the data collected from these sensors can be recorded and transmitted to a computer for further analysis by a race crew.

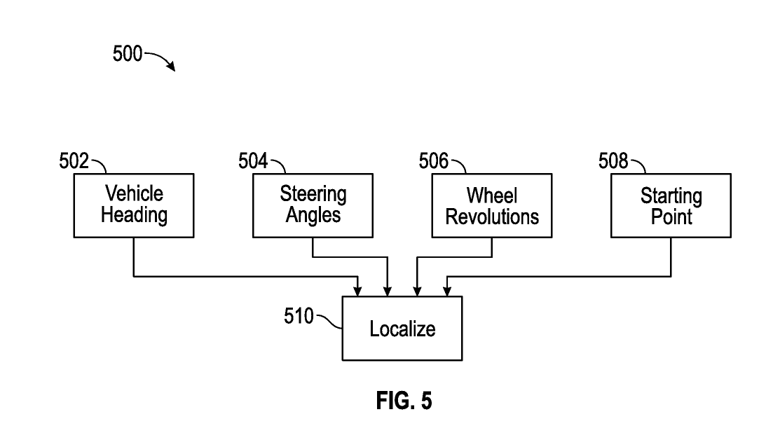

FIG. 5 illustrates exemplary process 500 for localizing (e.g., locating) a vehicle using calibrated vehicle dynamics expectations according to examples of the disclosure. Process 500 can be performed continuously or repeatedly by the vehicle during driving procedures.

At step 502, the vehicle's heading can be monitored (e.g., as described above with references to FIGS. 1-4). In some examples, the vehicle's heading can be monitored through a plurality of camera's and/or sensors around the vehicle (e.g., as described above with references to FIGS. 3A-4). For example, cameras on the vehicle can be used to capture images as the vehicle travels to determine its heading. At step 504, the vehicle's steering angle can be monitored (e.g., as described above with references to FIGS. 1-4). In some examples, the vehicle's steering angle can be monitored though a plurality of cameras pointed at the wheels. In some examples, the vehicle's steering angle can be monitored through a plurality of sensors pointing at the wheels and/or on the wheel themselves. For example, laser sensors can be placed pointing straight down just above each wheel. These sensors can then determine the rotation of each wheel. In some examples, the slip angle of the vehicle can be monitored at step 504 through a plurality of cameras and/or sensors on the vehicle. At step 506, the number of wheel revolutions (e.g., wheel speed) can be monitored. For example, the vehicle can be equipped with speed sensors at each wheel to measure wheel revolutions. In some examples, the vehicle can use the wheel speed sensors from its ABS system. At step 508, process 500 can keep track of a starting point (e.g. as described above with reference to FIGS. 3A-4). In some examples, the starting point can be the last known (or last accurate) GPS location of the vehicle. At step 510, process 500 can determine the vehicle's location based on the data from steps 502, 504, 506, and/or 508 (e.g., as described above with references to FIGS. 1-4). For example, process 500 can determine the location of the vehicle through vehicle odometry by calculating how far the vehicle traveled from the starting point from step 508 (e.g., as described above with references to FIGS. 1-4). In some examples, process 500 can be run when the vehicle's GPS receivers are unavailable (e.g., the vehicle does not have a direct line of sight to sufficient GPS satellites or the GPS receivers are otherwise malfunctioning).

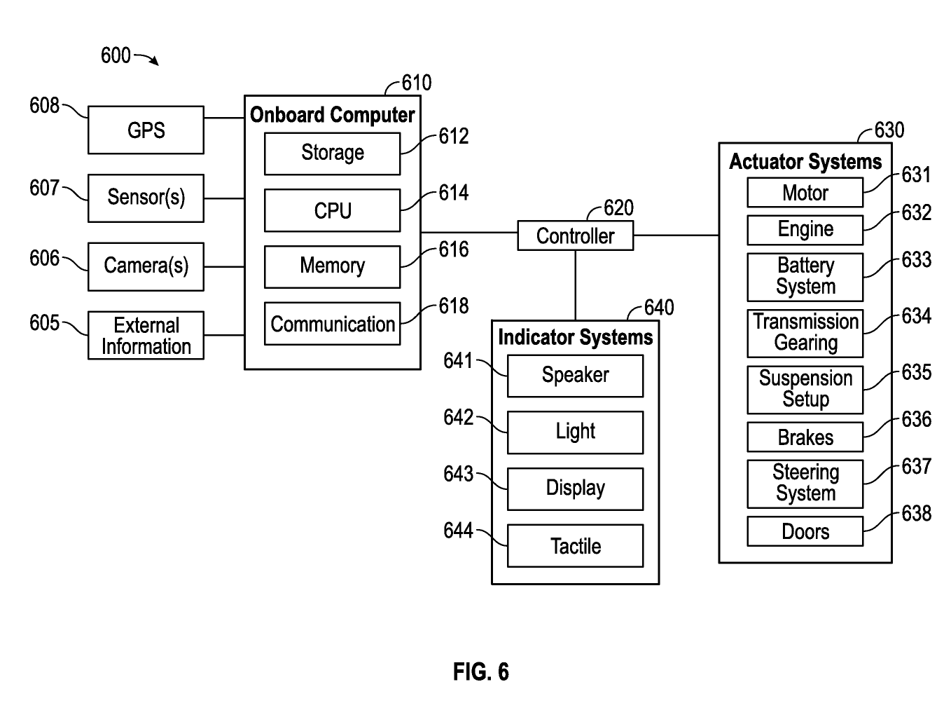

FIG. 6 illustrates an exemplary system block diagram of vehicle control system 600 according to examples of the disclosure. Vehicle control system 600 can perform any of the methods described with references to FIGS. 1-5. System 600 can be incorporated into a vehicle, such as a consumer automobile. Other examples of vehicles that may incorporate the system 600 include, without limitation, airplanes, boats, or industrial automobiles. Vehicle control system 600 can include one or more cameras 606 capable of capturing image data (e.g., video data) for determining various characteristics of the vehicle's surroundings, as described above with reference to FIGS. 1-5. Vehicle control system 600 can also include one or more other sensors 607 (e.g., radar, ultrasonic, LIDAR, accelerometer, or gyroscope) and a GPS receiver 608 capable of determining vehicle's location, orientation, heading, steering angle, slip angle, wheel speed, and/or any other vehicle dynamics characteristic. In some examples, sensor data can be fused together. This fusion can occur at one or more electronic control units (ECUs) (not shown). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance. Vehicle control system 600 can also receive (e.g., via an internet connection) external information such as map and/or weather information from other vehicles or from an internet source via an external information interface 605 (e.g., a cellular Internet interface or a Wi-Fi Internet interface). Vehicle control system 600 can include an on-board computer 610 that is coupled to cameras 606, sensors 607, GPS receiver 608, and map information interface 605, and that is capable of receiving the image data from the cameras and/or outputs from the sensors 607, the GPS receiver 608, and the external information interface 605. On-board computer 610 can be capable of calibrating vehicle dynamics expectations, as described in this disclosure. On-board computer 610 can include storage 612, memory 616, and a processor 614. Processor 614 can perform any of the methods described with reference to FIGS. 1-5. Additionally, storage 612 and/or memory 616 can store data and instructions for performing any of the methods described with reference to FIGS. 1-5. Storage 612 and/or memory 616 can be any non-transitory computer readable storage medium, such as a solid-state drive or a hard disk drive, among other possibilities. The vehicle control system 600 can also include a controller 620 capable of controlling one or more aspects of vehicle operation, such as performing autonomous or semi-autonomous driving maneuvers using vehicle dynamics expectation calibrations made by the on-board computer 610.

In some examples, the vehicle control system 600 can be connected (e.g., via controller 620) to one or more actuator systems 630 in the vehicle and one or more indicator systems 640 in the vehicle. The one or more actuator systems 630 can include, but are not limited to, a motor 631 or engine 632, battery system 633, transmission gearing 634, suspension setup 635, brakes 636, steering system 637, and door system 638. The vehicle control system 600 can control, via controller 620, one or more of these actuator systems 630 during vehicle operation; for example, to open or close one or more of the doors of the vehicle using the door actuator system 638, to control the vehicle during autonomous driving or parking operations, which can utilize the calibrations to vehicle dynamics expectations made by the on-board computer 610, using the motor 631 or engine 632, battery system 633, transmission gearing 634, suspension setup 635, brakes 636, and/or steering system 637, etc. The one or more indicator systems 640 can include, but are not limited to, one or more speakers 641 in the vehicle (e.g., as part of an entertainment system in the vehicle), one or more lights 642 in the vehicle, one or more displays 643 in the vehicle (e.g., as part of a control or entertainment system in the vehicle), and one or more tactile actuators 644 in the vehicle (e.g., as part of a steering wheel or seat in the vehicle). The vehicle control system 600 can control, via controller 620, one or more of these indicator systems 640 to provide indications to a driver. On-board computer 610 can also include in its memory 616 program logic for correcting the vehicle's trajectory when the processor receives inputs from one or more of the cameras 606, sensors 606, GPS receiver 608, and/or external information 605. When odometry discrepancies are detected, as described in this disclosure, on-board computer 610 can instruct the controller 620 to correct the vehicle's trajectory.

Thus, the examples of the disclosure provide various ways to calibrate vehicle dynamics expectations for autonomous vehicle navigation and localization.

Therefore, according to the above, some examples of the disclosure are directed to a system comprising: one or more sensors; one or more processors operatively coupled to the one or more sensors; and a memory including instructions, which when executed by the one or more processors, cause the one or more processors to perform a method comprising: while navigating a vehicle along a driving path: determining a first starting point along the driving path via the one or more sensors; monitoring a first vehicle trajectory from the first starting point to a first ending point via the one or more sensors, wherein the first vehicle trajectory comprises odometry information; calculating a first expected ending point of the first vehicle trajectory using the first starting point, the odometry information, and one or more vehicle dynamics expectations; determining whether there is a difference between the first ending point and the first expected ending point that is greater than a threshold distance; and in response to the determination: in accordance with a determination that the difference between the first ending point and the first expected ending point is greater than the threshold distance, calibrating the one or more vehicle dynamics expectations; and in accordance with a determination that the difference between the first ending point and the first expected ending point is not greater than the threshold distance, foregoing calibrating the one or more vehicle dynamics expectations. Additionally or alternatively to one or more of the examples disclosed above, in some examples, navigating the vehicle along the driving path comprises calculating a set of instructions for performing automated driving maneuvers for navigating the vehicle along the driving path based in part on the one or more vehicle dynamics expectations, and the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations. Additionally or alternatively to one or more of the examples disclosed above, in some examples, monitoring the vehicle trajectory from the first starting point to the first ending point via the one or more sensors comprises determining the location of the first ending point via one or more GPS receivers, optical cameras, ultrasound sensors, radar sensors, LIDAR sensors, cellular positioning systems, and cloud services. Additionally or alternatively to one or more of the examples disclosed above, in some examples, localizing the vehicle based on one or more of heading information, a steering angle, wheel revolutions, and a second starting point, different from the first starting point. Additionally or alternatively to one or more of the examples disclosed above, in some examples, the one or more sensors comprises one or more GPS receivers, and the one or more GPS receivers are unavailable. Additionally or alternatively to one or more of the examples disclosed above, in some examples, monitoring the vehicle trajectory from the first starting point to the first ending point via the one or more sensors comprises monitoring external information. Additionally or alternatively to one or more of the examples disclosed above, in some examples, the external information is received from one or more of another vehicle and an internet source. Additionally or alternatively to one or more of the examples disclosed above, in some examples, the external information comprises one or more of weather information and map information. Additionally or alternatively to one or more of the examples disclosed above, in some examples, calibrating the one or more vehicle dynamics expectations incorporates the one or more of weather information and map information. Additionally or alternatively to one or more of the examples disclosed above, in some examples, determining a second starting point, different from the first starting point, along the driving path via the one or more sensors; monitoring a second vehicle trajectory from the second starting point to a second ending point, different from the first ending point, via the one or more sensors; calculating a second expected ending point of the second vehicle trajectory using the second starting point, the odometry information, and the one or more vehicle dynamics expectations; determining whether there is a difference between the second ending point and the second expected ending point that is greater than the threshold distance; and in response to the determination: in accordance with a determination that the difference between the second ending point and the second expected ending point is greater than the threshold distance, calibrating the one or more vehicle dynamics expectations; and in accordance with a determination that the difference between the second ending point and the second expected ending point is not greater than the threshold distance, foregoing calibrating the one or more vehicle dynamics expectations. Additionally or alternatively to one or more of the examples disclosed above, in some examples, the one or more vehicle dynamics expectations have been calibrated at least once.

Some examples of the disclosure are directed to a non-transitory computer-readable medium including instructions, which when executed by one or more processors, cause the one or more processors to perform a method comprising: while navigating a vehicle along a driving path: determining a first starting point along the driving path via one or more sensors; monitoring a first vehicle trajectory from the first starting point to a first ending point via the one or more sensors, wherein the first vehicle trajectory comprises odometry information; calculating a first expected ending point of the first vehicle trajectory using the first starting point, the odometry information, and one or more vehicle dynamics expectations; determining whether there is a difference between the first ending point and the first expected ending point that is greater than a threshold distance; and in response to the determination: in accordance with a determination that the difference between the first ending point and the first expected ending point is greater than the threshold distance, calibrating the one or more vehicle dynamics expectations; and in accordance with a determination that the difference between the first ending point and the first expected ending point is not greater than the threshold distance, foregoing calibrating the one or more vehicle dynamics expectations. Additionally or alternatively to one or more of the examples disclosed above, in some examples, navigating the vehicle along the driving path comprises calculating a set of instructions for performing automated driving maneuvers for navigating the vehicle along the driving path based in part on the one or more vehicle dynamics expectations, and the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations.

Some examples of the disclosure are directed to a vehicle comprising: one or more sensors; one or more processors coupled to the one or more sensors; and a memory including instructions, which when executed by the one or more processors, cause the one or more processors to perform a method comprising: while navigating the vehicle along a driving path: determining a first starting point along the driving path via the one or more sensors; monitoring a first vehicle trajectory from the first starting point to a first ending point via the one or more sensors, wherein the first vehicle trajectory comprises odometry information; calculating a first expected ending point of the first vehicle trajectory using the first starting point, the odometry information, and one or more vehicle dynamics expectations; determining whether there is a difference between the first ending point and the first expected ending point that is greater than a threshold distance; and in response to the determination: in accordance with a determination that the difference between the first ending point and the first expected ending point is greater than the threshold distance, calibrating the one or more vehicle dynamics expectations; and in accordance with a determination that the difference between the first ending point and the first expected ending point is not greater than the threshold distance, foregoing calibrating the one or more vehicle dynamics expectations. Additionally or alternatively to one or more of the examples disclosed above, in some examples, navigating the vehicle along the driving path comprises calculating a set of instructions for performing automated driving maneuvers for navigating the vehicle along the driving path based in part on the one or more vehicle dynamics expectations, and the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations.

Some examples of the disclosure are directed to a method comprising: while navigating a vehicle along a driving path: determining a first starting point along the driving path via one or more sensors; monitoring a first vehicle trajectory from the first starting point to a first ending point via the one or more sensors, wherein the first vehicle trajectory comprises odometry information; calculating a first expected ending point of the first vehicle trajectory using the first starting point, the odometry information, and one or more vehicle dynamics expectations; determining whether there is a difference between the first ending point and the first expected ending point that is greater than a threshold distance; and in response to the determination: in accordance with a determination that the difference between the first ending point and the first expected ending point is greater than the threshold distance, calibrating the one or more vehicle dynamics expectations; and in accordance with a determination that the difference between the first ending point and the first expected ending point is not greater than the threshold distance, foregoing calibrating the one or more vehicle dynamics expectations. Additionally or alternatively to one or more of the examples disclosed above, in some examples, navigating the vehicle along the driving path comprises calculating a set of instructions for performing automated driving maneuvers for navigating the vehicle along the driving path based in part on the one or more vehicle dynamics expectations, and the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more sensors;
one or more processors operatively coupled to the one or more sensors; and
a memory including instructions, which when executed by the one or more processors, cause the one or more processors to perform a method comprising:
while navigating a vehicle along a driving path:
determining a first starting point along the driving path via the one or more sensors;
monitoring a first vehicle trajectory from the first starting point to a first ending point via the one or more sensors, wherein the first vehicle trajectory comprises odometry information;
calculating a first expected ending point of the first vehicle trajectory using the first starting point, the odometry information, and one or more vehicle dynamics expectations;
determining whether there is a difference between the first ending point and the first expected ending point that is greater than a threshold distance; and
in response to the determination:
in accordance with a determination that the difference between the first ending point and the first expected ending point is greater than the threshold distance, calibrating the one or more vehicle dynamics expectations; and
in accordance with a determination that the difference between the first ending point and the first expected ending point is not greater than the threshold distance, foregoing calibrating the one or more vehicle dynamics expectations.

2. The system of claim 1, wherein:
navigating the vehicle along the driving path comprises calculating a set of instructions for performing automated driving maneuvers for navigating the vehicle along the driving path based in part on the one or more vehicle dynamics expectations, and
the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations.

3. The system of claim 1, wherein:
monitoring the vehicle trajectory from the first starting point to the first ending point via the one or more sensors comprises determining the location of the first ending point via one or more GPS receivers, optical cameras, ultrasound sensors, radar sensors, LIDAR sensors, cellular positioning systems, and cloud services.

4. The system of claim 1, wherein the method further comprises:
localizing the vehicle based on one or more of heading information, a steering angle, wheel revolutions, and a second starting point, different from the first starting point.

5. The system of claim 4, wherein:
the one or more sensors comprises one or more GPS receivers, and the one or more GPS receivers are unavailable.

6. The system of claim 1, wherein:
monitoring the vehicle trajectory from the first starting point to the first ending point via the one or more sensors comprises monitoring external information.

7. The system of claim 6, wherein the external information is received from one or more of another vehicle and an internet source.

8. The system of claim 6, wherein the external information comprises one or more of weather information and map information.

9. The system of claim 8, wherein calibrating the one or more vehicle dynamics expectations incorporates the one or more of weather information and map information.

10. The system of claim 1, wherein the method further comprises:
determining a second starting point, different from the first starting point, along the driving path via the one or more sensors;
monitoring a second vehicle trajectory from the second starting point to a second ending point, different from the first ending point, via the one or more sensors;
calculating a second expected ending point of the second vehicle trajectory using the second starting point, the odometry information, and the one or more vehicle dynamics expectations;
determining whether there is a difference between the second ending point and the second expected ending point that is greater than the threshold distance; and
in response to the determination:
in accordance with a determination that the difference between the second ending point and the second expected ending point is greater than the threshold distance, calibrating the one or more vehicle dynamics expectations; and
in accordance with a determination that the difference between the second ending point and the second expected ending point is not greater than the threshold distance, foregoing calibrating the one or more vehicle dynamics expectations.

11. The system of claim 10, wherein the one or more vehicle dynamics expectations have been calibrated at least once.

12. A vehicle comprising:
one or more sensors;
one or more processors coupled to the one or more sensors; and
a memory including instructions, which when executed by the one or more processors, cause the one or more processors to perform a method comprising:
while navigating the vehicle along a driving path:
determining a first starting point along the driving path via the one or more sensors;
monitoring a first vehicle trajectory from the first starting point to a first ending point via the one or more sensors, wherein the first vehicle trajectory comprises odometry information;
calculating a first expected ending point of the first vehicle trajectory using the first starting point, the odometry information, and one or more vehicle dynamics expectations;
determining whether there is a difference between the first ending point and the first expected ending point that is greater than a threshold distance; and
in response to the determination:
in accordance with a determination that the difference between the first ending point and the first expected ending point is greater than the threshold distance, calibrating the one or more vehicle dynamics expectations; and
in accordance with a determination that the difference between the first ending point and the first expected ending point is not greater than the threshold distance, foregoing calibrating the one or more vehicle dynamics expectations.

13. The vehicle of claim 12, wherein:
navigating the vehicle along the driving path comprises calculating a set of instructions for performing automated driving maneuvers for navigating the vehicle along the driving path based in part on the one or more vehicle dynamics expectations, and
the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations.

14. A method comprising:
while navigating a vehicle along a driving path:
determining a first starting point along the driving path via one or more sensors;
monitoring a first vehicle trajectory from the first starting point to a first ending point via the one or more sensors, wherein the first vehicle trajectory comprises odometry information;
calculating a first expected ending point of the first vehicle trajectory using the first starting point, the odometry information, and one or more vehicle dynamics expectations;
determining whether there is a difference between the first ending point and the first expected ending point that is greater than a threshold distance; and
in response to the determination:
in accordance with a determination that the difference between the first ending point and the first expected ending point is greater than the threshold distance, calibrating the one or more vehicle dynamics expectations; and
in accordance with a determination that the difference between the first ending point and the first expected ending point is not greater than the threshold distance, foregoing calibrating the one or more vehicle dynamics expectations.

15. The method of claim 14, wherein:
navigating the vehicle along the driving path comprises calculating a set of instructions for performing automated driving maneuvers for navigating the vehicle along the driving path based in part on the one or more vehicle dynamics expectations, and
the method further comprises, in accordance with the determination that the difference between the first ending point and the first expected ending point is greater than the threshold distance, updating the set of instructions for performing the automated driving maneuvers for navigating the vehicle along the driving path based in part on the calibrated one or more vehicle dynamics expectations.
